(19) United States
(12) Patent Application Publication
(10) Pub. No.: US 2005/0135204 A1
(43) Pub. Date: Jun. 23, 2005

(54) METHOD FOR IDENTIFYING TRACK CAPACITY

(76) Inventors: Yuan-Ting Wu, Hsin-Chu City (TW); Tse-Hong Wu, Tai-Nan City (TW)

Correspondence Address: NORTH AMERICA INTERNATIONAL PATENT OFFICE (NAIPC), P.O. BOX 506, MERRIFIELD, VA, 22116, US

(21) Appl. No.: 10/711,933

(22) Filed: Oct. 13, 2004

(30) Foreign Application Priority Data
Dec. 22, 2003 (TW) 092136384

(51) Int. Cl. G11B 7/085

(52) U.S. Cl. 369/30.1; 369/53.37

(57) ABSTRACT

A method for identifying the track capacity of a track on an optical disk, the method includes utilizing an optical disk drive to determine if any link block exists in any track of a session having a target track; determining the write mode of the target track; and calculating the track capacity of the target track according to its write mode. If the write mode of the target track is disk-at-once, session-at-once, or RAW mode, the pre-gap is excluded from the track capacity of the target track. If the write mode is track-at-once or variable packet write mode, the pre-gap and link blocks in track end is excluded from the track capacity of the target track. If the write mode is in fixed packet write mode, the pre-gap and link blocks among all packets within the target track is excluded from the track capacity of the target track.

### BACKGROUND

The present invention relates to a method for identifying the track capacity of an optical disk, and more particularly, to a method for identifying the track capacity of an optical disk in an optical disk drive.

As information technology advances, optical disks are widely applied in data storage. In general, a track is the basic unit of measurement for recorded data in an optical disk. The length of track, however, is not fixed. For example, in the case of music CDs, each song is a single track, and in the case of data CDs, it is possible that a plurality of files is stored in a single track.

There are many kinds of write modes for optical disks, such as disc-at-once (DAO), session-at-once (SAO), RAW, track-at-once (TAO), fixed packet write (FPKT), variable packet write (VPKT), and so on. In the case of DAO or SAO, data is written onto an optical disk all at once in the form of a session, wherein each track of the session has no link blocks. In the case of RAW, data is also written onto an optical disk all at once in the form of a session to reduce the complexity of software control. That is to say, in the case of RAW, generally each track of the session has no link blocks either.

However, some write modes employ link blocks in the track. The write mode TAO, for example, writes data as a track onto the optical disk, wherein each track has link blocks at the track start and track end. In additional, the write mode FPKT or VPKT writes data as a track onto the optical disk with packets, which results in many link blocks in each track.

The term “track capacity” means the sum of user blocks which capable of recording data. The other blocks, such as pre-gap and link blocks should not be counted in the actual track capacity of a track.

As can be inferred from the above, the write mode of the track needs to be known before the track capacity can be correctly calculated. In the related art, when an optical disk drive receives an instruction from a host for inquiry about the track capacity of a target track, the optical disk drive cannot determine the write mode of the target track unless the write mode of the track is FPKT or VPKT. Therefore, the optical disk must access the table of contents (TOC) of the session that the target track belongs to and report to the host the track capacity according to the track size recorded in the TOC. Obviously, when the target track has link blocks, the track capacity reported to the host is not the actual capacity of the target track due to the inability of the optical disk drive to exclude link blocks of the target track from its track capacity in accordance with related art.

Furthermore, another problem of the related art is that it consumes too much time to perform track-seeking (or tracking) and to access the track descriptor block (TDB) of the target track. When the host inquires about the track capacity of a target track with a write mode of FPKT or VPKT, the optical disk drive needs to perform track-seeking to move the pick-up head in order to access the TDB of the target track. The above-mentioned action has a negative effect for system performance.

### SUMMARY OF INVENTION

It is therefore an objective of the claimed invention to provide a method for identifying track capacity of an optical disk according to the write mode of the track in order to obtain actual track capacity.

The preferred embodiment of the claimed invention discloses a method for identifying track capacity of a track of an optical disk in an optical disk drive, the method comprising: (a) checking if any track of a session having a target track has link blocks; (b) determining the write mode of the target track; and (c) calculating track capacity of the target track according to its write mode.

One advantage of the present invention is that the write mode of the target track can be correctly determined by checking if any track having link blocks exists in the session that the target track belongs to.

Another advantage of the present invention is that the actual track capacity of the target track can be obtained by calculating the track capacity of the target track according to its write mode.

Yet another advantage of the present invention is it reduces required time for performing track-seeking when the optical disk drive calculates the track capacity and thereby improves calculation efficiency of track capacity.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of an optical disk drive according to the present invention.

FIG. 2 is a flowchart of the method according to the present invention to identify track capacity of a target track on an optical disk.

FIG. 3 is a flowchart of the method according to the present invention used in a read-only optical disk drive to identify track capacity of a target track on an optical disk.

### DETAILED DESCRIPTION

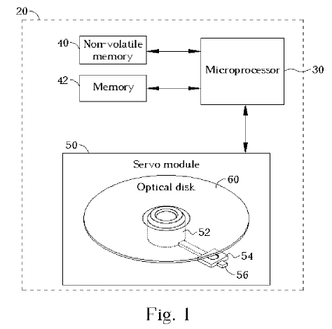

FIG. 1 illustrates a schematic diagram of an optical disk drive 20 in accordance with the present invention. The optical disk drive 20 comprises a microprocessor 30, a non-volatile memory 40, a memory 42, and a servo module 50. The servo module 50 has a spindle 52, a pick-up head 54, and other required electrical components. The spindle 52 is used for rotating an optical disk 60; the pick-up head 54 slides along a guide bar 56 to access data on different tracks of the optical disk 60. When the optical disk receives a instruction to query about the track capacity of a track on the optical disk 60 from a host (not shown), the optical disk drive 20 utilizes the microprocessor 30 to execute firmware code stored in the non-volatile memory 40 in order to control the servo module 50 to access the optical disk 60. In a preferred embodiment, the non-volatile memory 40 can be a flash memory and the optical disk drive 20 can be a read-only optical disk drive or a recordable optical disk drive. The optical disk drive 20 of the present invention is used for determining the write mode of each session of the optical disk 60 and the write mode of each track in each session and for calculating actual capacity of each track on the optical disk 60 based on its write mode.

As mentioned above, actual track capacity of a track means the sum of size of each user block of the track. The other blocks of the track, such as pre-gap (or “pause” for an audio track) or link blocks should not be counted in the actual capacity of the track.

In the case of a track in DAO, SAO, or RAW mode, no link blocks exists at track start or track end of the track. Thus, the optical disk drive 20 of the present invention only needs to exclude the pre-gap of the track from the track size when calculating the actual track capacity of the track.

In the case of a track of TAO mode, link blocks exist at both the track start and track end of the track. Since the link blocks (five run-in blocks) at the track start belongs to the pre-gap of the track, the optical disk drive 20 should exclude the pre-gap and the last two link blocks (two run-out blocks) of the track from the track size when calculating the actual track capacity of the track of TAO mode.

In the case of a track of VPKT mode, link blocks not only exist at the track start and track end of the track, but also within the track. The number of link blocks within the track, however, is ignored due to the difficulty in counting them. Therefore the calculation means of the actual track capacity is substantially the same as the track of TAO mode. Similarly, since the five run-in blocks belongs to the pre-gap of the track, the optical disk drive 20 should exclude the pre-gap and the last two link blocks (run-out blocks) of the track from the track size when calculating the actual track capacity of the track of VPKT mode.

In the case of a track of FPKT mode, link blocks not only exist at both the track start and track end, but also exist among packets. Thus, the optical disk drive 20 should exclude the pre-gap and all link blocks among packets of the track from the track size when calculating the actual track capacity of the track of FPKT mode.

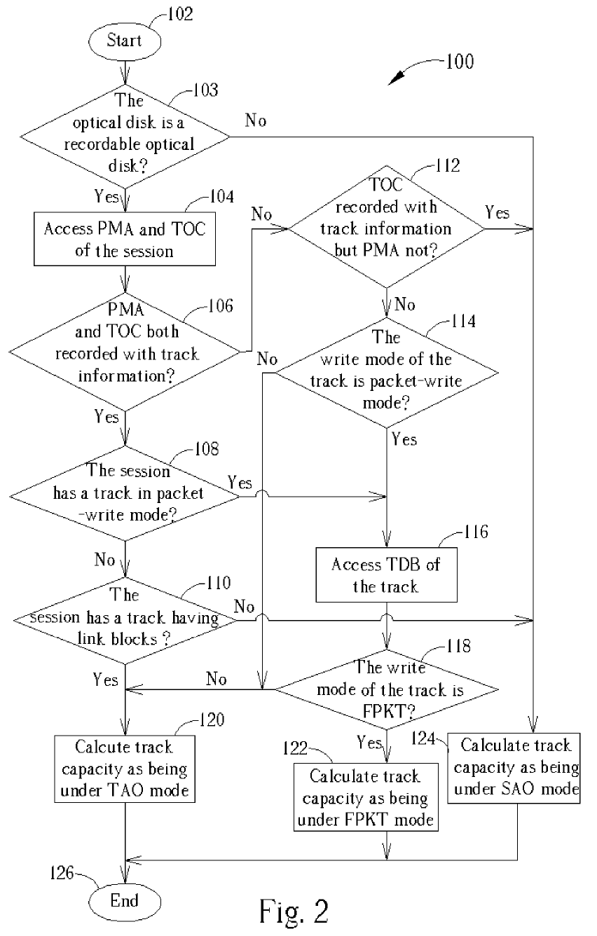

In the following, a flowchart is employed to elaborate the operation of the optical disk drive 20 in accordance with the present invention. Please refer to FIG. 2, as well as FIG. 1. FIG. 2 depicts a flowchart of a method for identifying track capacity of a target track on an optical disk according to the present invention. The flowchart involves following steps:

Step 102: Start.

Step 103: Determine if the optical disk 60 is recordable/re-writable. If the optical disk 60 is a recordable optical disk or a re-writable optical disk, the optical disk drive 20 performs Step 104. If the optical disk 60 is a read-only optical disk, it performs Step 124.

Step 104: Access the program memory area (PMA) of the optical disk 60 and the table of contents (TOC) of the session to which the target track belongs.

Step 106: Determine if the PMA of the optical disk 60 and the TOC of the session both have the track information of the session recorded. If true, then the optical disk drive 20 performs Step 108. If the PMA of the optical disk 60 does not have the track information of the session recorded or the TOC of the session does not exist, then perform Step 112.

Step 108: Check if any track in packet-write mode exists in the session. If true, then the optical disk drive 20 performs Step 116; otherwise, it performs Step 110.

Step 110: Check if any track having link blocks exists in the session. If true, the optical disk drive 20 performs Step 120; otherwise, it performs Step 124.

Step 112: If the TOC of the session has the track information of the session recorded but the PMA of the optical disk 60 does not, then the optical disk drive 20 performs Step 124 for the session. If the PMA has the track information of the session recorded but the TOC of the session does not exist, then it performs Step 114 for the session.

Step 114: Determine whether or not the write mode of each track of the session is in packet-write mode according to the contents of the PMA. If no track in packet-write mode exists in the session or the write mode of the target track is not packet-write, the optical disk drive 20 performs Step 120. If the write mode of the target track is packet-write, it performs Step 116.

Step 116: Utilize the pick-up head 54 of the optical disk drive 20 to access the track descriptor block (TDB) of the target track.

Step 118: The microprocessor 30 determines whether the write mode of the target track is FPKT or VPKT. If the write mode of the target track is FPKT, the optical disk drive 20 performs Step 122. If the write mode is VPKT, it performs Step 120.

Step 120: The microprocessor 30 calculates the actual track capacity of the target track as a track recorded under TAO.

Step 122: According to the packet size of the target track obtained from the TDB of the target track, the microprocessor 30 calculates actual track capacity of the target track as a track recorded under FPKT.

Step 124: The microprocessor 30 calculates actual track capacity of the target track as a track recorded under SAO.

Step 126: End. The microprocessor 30 records the result of calculation into the memory 42.

In practical implementation, steps 120, 122 and 124 can be ignored and the microprocessor 30 simply records the write mode of the target track into the memory 42 in order to calculate its actual track capacity when the host queries about the track capacity of the target track.

In a preferred embodiment, the optical disk drive 20 is a recordable optical disk drive.

Due to different write modes, the optical disk 60 may comprise one or more sessions recorded with data, and each session may also comprise one or more tracks. In a preferred embodiment, in order to reduce tracking actions and to improve response time when the host queries the optical disk drive 20 about the track capacity of the target track, the optical disk drive 20 executes the method for identifying track capacity according to the present invention when the optical disk 60 loads in.

As well known in the art, the optical disk 60 may have no program memory area (PMA), such as a read-only optical disk. Thus, in step 103, the optical disk drive 20 determines if the optical disk 60 is a recordable/re-writable optical disk. If it is a recordable/re-writable optical disk, then the optical disk drive 20 performs step 104 and following steps; otherwise, it means that the optical disk 60 has no PMA and each track of the optical disk 60 has no link blocks either. Therefore, the method for identifying track capacity of the present invention can directly jump to step 124 to calculate actual track capacity of the target track by excluding the pre-gap of the target track from its track size.

However, even if the PMA of the optical disk 60 existed, the PMA may not have the track information of the optical disk 60 recorded. Furthermore, it is uncertain that the tracks of the optical disk have a table of contents (TOC). This is because that the TOC of the session written in TAO or packet-write mode is written after the session is finished, the action known as session fixation (close session).

In step 104, the optical disk drive 20 accesses the PMA of the optical disk 60 and the TOC of the session, which the target track belongs to. Next, in step 106 and step 112, the optical disk drive 20 roughly determines the write mode of the session based on whether the PMA of the optical disk 60 and the TOC of the session are recorded with track information of the session. Under some specific conditions, the optical disk drive 20 can obtain the write mode of the session or the target track accordingly.

For example, imagine there is a session A on an optical disk. If the optical disk drive 20 finds that the PMA of the optical disk 60 does not have the track information of session A recorded but the TOC of the session A exists, the optical disk drive 20 can then make a conclusion that session A is either a session of a CD-ROM disk or a session of DAO, SAO or RAW mode of a CD-R/RW disk. As mentioned above, in this situation, each track of the session A has no link blocks at the track start or track end. Therefore, in step 124, when the optical disk drive 20 utilizes the microprocessor 30 to calculate track capacity of a target track A1 of the session A, the actual track capacity of the target track A1 can be obtained by excluding the pre-gap of the target track A1 from its track size.

On the other hand, imagine there is a session B on an optical disk. If, in steps 106 and 112, the optical disk drive 20 finds that the PMA of the optical disk 60 has the track information of the session B recorded but the TOC of the session does not exist, it means session fixation has not yet been performed on session B. Thus, the optical disk drive 20 can make a conclusion that the write mode of the session B is not DAO, SAO or RAW but could be TAO or packet-write. At that time, the optical disk drive 20 can determine whether the write mode of each track of the session B is packet-write mode or not according to the contents of the PMA of the optical disk 60 in step 114.

If the optical disk drive 20 finds the write mode of a target track B1 of the session B is not in packet-write mode according to the PMA of the optical disk 60, then the optical disk drive 20 can make a conclusion that the write mode of the target track B1 is in TAO. Next, in step 120, when the microprocessor 30 calculates the actual track capacity of the target track B1, the microprocessor 30 obtains the actual track capacity of the target track B1 by excluding the pre-gap of the target track B1 and the last two link blocks (run-out blocks) from its track size. It means the pre-gap and the last two link blocks of the target track B1 are not counted in the actual track capacity of the target track B1.

On the other hand, if the optical disk drive 20 finds the write mode of a target track B2 of the session B is in packet-write mode according to the PMA of the optical disk 60, the optical disk drive 20 next utilizes the pick-up head 54 to access the TDB of the target track B2 in step 116. The TDB of each packet-written track is recorded in its pre-gap. In step 118, the optical disk drive 20 can make a conclusion that the write mode of the target track B2 is FPKT or VPKT after the optical disk drive 20 reads the TDB of the target track B2. If the write mode of the target track B2 is VPKT, the microprocessor 30 in step 120 calculates the track capacity of the target track B2 as well as if a track is in TAO mode. The microprocessor 30 obtains the actual track capacity of the target track B2 by excluding the pre-gap and the last two link blocks of the target track B2 from its track size. If the write mode of the target track B2 is FPKT, the microprocessor 30 calculates the actual track capacity of the target track B2 by excluding the pre-gap and all other link blocks among packets of the track B2 from its track size.

Now imaging that the optical disk has a session C. If the optical disk drive 20 finds the PMA of the optical disk 60 has the track information of session C recorded and the TOC of the session C also exists, then in step 106 the optical disk drive 20 determines whether any track in packet-write mode exists in session C according to the TOC of the session C. If the TOC of the session C records that the write mode of a target track C1 is in packet-write mode, then in step 116 the optical disk drive 20 further reads the TDB of the target track C1 to make sure that the write mode of the target track C1 is FPKT or VPKT. Additionally, the optical disk drive 20 can make a conclusion that the write mode of other tracks that are not in packet-write mode of the session C is in TAO mode.

In step 108, however, if the write mode of each track of session C is not in packet-write mode, the optical disk drive 20 utilizes the pick-up head 54 to access the first track of the session C in step 110. In the case of TAO mode, the track start and track end of a track both have link blocks (run-in and run-out blocks respectively). Therefore, in a preferred embodiment of the present invention, the pick-up head 54 reads the track start of the first track of session C to determine whether the first track of session C has link blocks or not. If the track-start of the first track of the session C has link blocks, it means the write mode of the first track of session C is in TAO, and it further implies the write mode of each track of the session C is in TAO too. If the first track of the session C has no link blocks, then it means the write mode of the session C is in DAO, SAO or RAW. Next, in step 124, the microprocessor 30 can simply exclude the pre-gap of the target track C2 from the track size to obtain the actual track capacity of a target track C2.

Please note, in a preferred embodiment of the present invention, the microprocessor 30 stores the actual track capacity of the target track of the optical disk 60 into the memory 42 in step 126. In another embodiment of the present invention, the microprocessor 30 can ignore steps 120, 122 and 124, and store the write mode of the target track into the memory 42. The microprocessor 30 calculates the actual track capacity of the target track according to the write mode stored in the memory 42 when the host queries about the track capacity of the target track. Thus, when the host requests the track capacity of the target track, the optical disk drive 20 of the present invention can transmit the actual track capacity of the target track from the memory 42 to the host (or calculate the actual track capacity of the target track according to the write mode stored in the memory 42 and returns the calculation result to the host) instead of moving the pick-up head 54 to access the TOC of the session, which the target track belongs to, according to the related art.

Additionally, in a preferred embodiment of the present invention, the method for identifying actual track capacity of the present invention can be applied in the initialization process when the optical disk 60 loads into the optical disk drive 20. The optical disk drive 20 determines write mode of each track of the optical disk 60 (or calculates actual track capacity of each track) and stores the result into the memory 42 in order to improve response speed and correctness when the host requests track capacity of any track of the optical disk 60.

As mentioned above, the present invention has following advantages: first of all, in the initialization process when the optical disk 60 loads in, the optical disk drive 20 can utilize the microprocessor 30 to identify actual track capacity (or write mode) of each track of the optical disk 60 and store the results in the memory 42. Therefore, when the host queries the optical disk drive 20 about the track capacity of any track of the optical disk 60, the optical disk drive 20 just needs to transmit the actual track capacity of the track from the memory 42 to the host or calculate the actual track capacity of the track according to the write mode stored in the memory 42 and return the calculation result to the host. Thus, the tracking action of the optical disk drive 20 of the present invention can be dramatically reduced. Second, in order to optimize performance, in the preferred embodiment of the present invention, the optical disk drive 20 reads the track-start of the first track of the session to minimize tracking distance of the determining process. Third, when calculating the track capacity of each track of the optical disk 60, the optical disk drive 20 adopts different calculation methods according to the write mode of each track respectively and thereby obtains the actual track capacity of each track to solve the problem of the related art.

Please note, the above advantages of the preferred embodiments do not limit practical implementation of the present invention. The method of the present invention is not limited to only being applied in the initialization process when the optical disk 60 loads into the optical disk drive 20. The method of the present invention can also be applied when the optical disk drive 20 receives an instruction to query about the track capacity of a target track from the host. In addition, in step 110 of the flowchart of the present invention, the optical disk drive 20 is not limited to accessing the first track of the session but can access any track of the session to determine whether the session has a track having link blocks.

Additionally, in the above elaboration, the optical disk drive 20 is assumed to be a recordable optical disk drive in order to conveniently illustrate the preferred embodiment of the present invention. Since the recordable optical disk drive is capable of accessing the PMA (if it exists) of the optical disk 60, it can thereby determine the write mode of some kinds of sessions with fewer steps. The method of the present invention, of course, can be applied in various types of read-only optical disk drives. If the optical disk drive 20 is a read-only optical disk drive, some steps related to the PMA of the optical disk 60 in the flowchart of FIG. 2 are ignored due to the optical disk drive 20 not being capable of accessing the PMA of the optical disk 60.

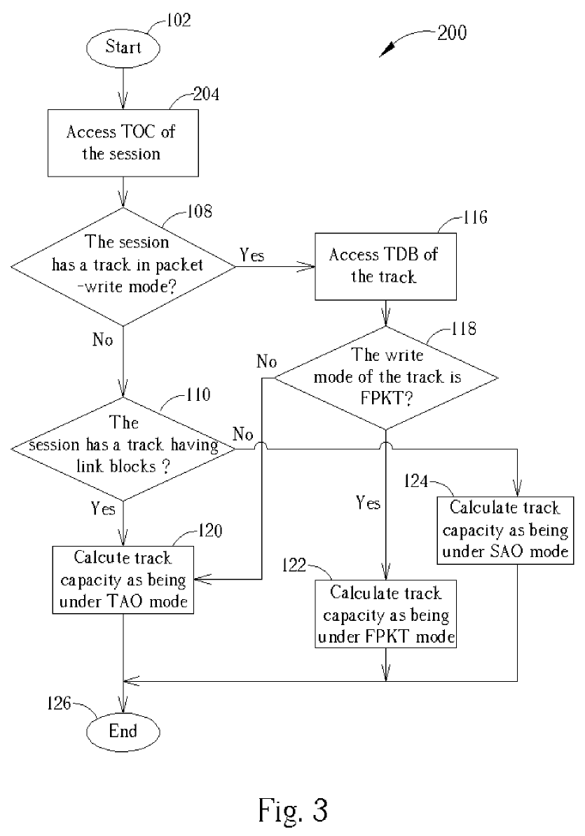

Please refer to FIG. 3 as well as FIG. 2. FIG. 3 depicts a flowchart 200 of the method of present invention as applied in a read-only optical disk drive. The flowchart 200 comprises following steps:

Step 102: Start.

Step 204: Access the table of contents (TOC) of a session, which the target track belongs to.

Step 108: Check if any track in packet-write mode exists in the session. If true, the optical disk drive 20 performs Step 116; otherwise, it performs Step 110.

Step 110: Check if any track having link blocks exists in the session. If true, the optical disk drive 20 performs Step 120; otherwise, it performs Step 124.

Step 116: Utilize the pick-up head 54 of the optical disk drive 20 to access the track descriptor block (TDB) of the target track.

Step 118: The microprocessor 30 determines whether the write mode of the target track is either FPKT or VPKT. If the write mode of the target track is FPKT, the optical disk drive 20 performs Step 122. If the write mode is VPKT, it performs Step 120.

Step 120: The microprocessor 30 calculates actual track capacity of the target track as a track recorded under TAO.

Step 122: According to the packet size of the target track obtained from the TDB of the target track, the microprocessor 30 calculates actual track capacity of the target track as a track recorded under FPKT.

Step 124: The microprocessor 30 calculates actual track capacity of the target track as a track recorded under SAO.

Step 126: End. The microprocessor 30 records the result of calculation into the memory 42.

Similarly, in practical implementation, the microprocessor 30 can ignore steps 120, 122 and 124 and simply record the write mode of the target track into the memory 42 and then calculate the actual track capacity when the host queries about the track capacity of the target track.

The flowchart 200 resembles the flowchart 100 and the same steps in the two flowcharts are both assigned the same number. The difference between the two flowcharts is that the flowchart 200 has no steps related to the PMA of the optical disk 60. The elaboration of each steps of the flowchart 200 is substantially the same as the flowchart 100; therefore, for brevity, further details are omitted here.

Similarly, the read-only optical disk drive 20 is not limited to perform the steps of the flowchart 200 when the optical disk 60 loads in. The read-only optical disk drive 20 can calculate the actual track capacity of a target track according to the method of the present invention till the host queries about track capacity of the target track.

In addition, the method for identifying the track capacity of the present invention also supports different kinds of CD-ROM disk. Since each CD-ROM disk has no PMA and has no track in packet-write mode either, the method for identifying the actual track capacity of each track on the CD-ROM disk is substantially the same as in the case of DAO, SAO or RAW mode.

As above-mentioned of the embodiments, the present invention has following features. First, the present invention can correctly identify the write mode of the target track by determining whether or not if any track having link blocks exists in the session to which the target track belongs. Second, the method of the present invention calculates the actual track capacity of each track according to its write mode respectively. Third, the present invention is capable of reducing the number of times tracking is done and thereby improves system performance.

Those skilled in the art will readily observe that numerous modifications and alterations of the device and method may be made while retaining the teachings of the invention. Accordingly, the above disclosure should be construed as limited only by the metes and bounds of the appended claims.

1. A method for identifying the track capacity of a track of an optical disk in an optical disk drive, the method comprising:
(a) checking if any track of a session having a target track has link blocks;
(b) determining the write mode of the target track; and
(c) calculating track capacity of the target track according to its write mode.

2. The method of claim 1 further comprising utilizing the optical disk drive to access the program memory area (PMA) of the optical disk and the table of contents (TOC) of the session having the target track, wherein step (c) further comprises setting actual capacity of the target track as the size of the target track excluding its pre-gap in the case that either the TOC exists but the PMA does not or the TOC and PMA exist but the track information of the session is not recorded in the PMA.

3. The method of claim 2, wherein the write mode of the target track is disc-at-once (DAO), session-at-once (SAO), or RAW.

4. The method of claim 1 further comprising utilizing the optical disk drive to access the program memory area (PMA) of the optical disk and the table of contents (TOC) of a session having the target track, wherein step (b) further comprises determining whether the write mode of the target track is a packet-write mode according to contents of the PMA in the case that the TOC does not exist but the PMA exists and the track information of the session is recorded in the PMA.

5. The method of claim 4, wherein step (c) further comprises setting actual capacity of the target track as the size of the target track excluding its pre-gap and last two link blocks when the write mode of the target track is not a packet-write mode.

6. The method of claim 4, further comprising accessing the track descriptor block (TDB) of the target track to determine whether the write mode of the target track is a fixed packet write (FPKT) or variable packet write (VPKT) when its write mode is a packet-write mode.

7. The method of claim 6, wherein step (c) further comprises setting actual capacity of the target track as the size of the target track excluding its pre-gap and last two link blocks when the write mode of the target track is VPKT.

8. The method of claim 6, wherein step (c) further comprises setting actual capacity of the target track as the size of the target track excluding its pre-gap and all link blocks when the write mode of the target track is FPKT.

9. The method of claim 1 further comprising utilizing the optical disk drive to access the program memory area (PMA) of the optical disk and the table of contents (TOC) of a session having the target track, and determining if any track of the session exists in a packet-write mode, wherein step (c) further comprises determining whether the write mode of the target track is a fixed packet write (FPKT) or variable packet write (VPKT) by accessing the track descriptor block (TDB) of the target track when the TOC and PMA exist, the track information of the session is recorded in the PMA, and the session has a track in packet-write mode.

10. The method of claim 9, wherein step (c) further comprises setting actual capacity of the target track as the size of the target track excluding its pre-gap and last two link blocks when the write mode of the target track is VPKT.

11. The method of claim 9, wherein step (c) further comprises setting actual capacity of the target track as the size of the target track excluding its pre-gap and all link blocks when the write mode of the target track is FPKT.

12. The method of claim 1, further comprising utilizing the optical disk drive to access the program memory area (PMA) of the optical disk and the table of contents (TOC) of a session having the target track, and determining if any track in the session exists in a packet-write mode, wherein step (c) further comprises setting the actual capacity of the target track as the target track excluding its pre-gap and last two link blocks when the TOC and PMA exist and the track information of the session is recorded in the PMA, the session has no track in packet-write mode, and in step (a) the track of the session has link blocks.

13. The method of claim 1, further comprising utilizing the optical disk drive to access the program memory area (PMA) of the optical disk and the table of contents (TOC) of a session having the target track, and determining if any track in the session exists in a packet-write mode, wherein step (c) further comprises setting the actual capacity of the target track as the size of the target track excluding its pre-gap when the TOC and PMA exist and the track information of the session is recorded in the PMA, the session has no track in packet-write mode, and in step (a) no track of the session has link blocks.

14. The method of claim 1, wherein the optical disk drive is a read-only optical disk drive or a recordable optical disk drive.

15. An optical disk drive for utilizing the method of claim 1 to identify track capacity of a track of an optical disk.

16. A method for determining the write mode of a track of an optical disk in an optical disk drive, the method comprising:
(a) utilizing the optical disk drive to determine if any track of a session having a target track has link blocks; and
(b) determining the write mode of the target track accordingly.

17. The method of claim 16, further comprising utilizing the optical disk drive to access the program memory area (PMA) of the optical disk and the table of contents (TOC) of a session having the target track, wherein if either the TOC exists but the PMA does not or the TOC and PMA exist but the track information of the session is not recorded in the PMA, the write mode of the target track is disc-at-once (DAO), session-at-one (SAO), or RAW.

18. The method of claim 16, further comprising utilizing the optical disk drive to access the program memory area (PMA) of the optical disk and the table of contents (TOC) of a session having the target track, wherein if the TOC does not exist but the PMA exists and the track information of the session is recorded in the PMA, the write mode of the target track is packet-write mode or track-at-once (TAO).

19. The method of claim 18, further comprising determining whether the write mode of the target track is a packet-write mode according to the contents of the PMA.

20. The method of claim 18, wherein step (b) further comprises accessing the track descriptor block (TDB) of the target track to determine whether the write mode of the target track is fixed packet write (FPKT) or variable packet write (VPKT) when the write mode is a packet-write mode.

21. The method of claim 16, further comprising utilizing the optical disk drive to access the program memory area (PMA) of the optical disk and the table of contents (TOC) of a session having the target track, and to determine if any track of packet-write mode exists in the session, wherein step (b) further comprises determining the write mode of the target track is fixed packet write (FPKT) or variable packet write (VPKT) by accessing the track descriptor block (TDB) of the target track when the TOC and the PMA exist with recording the track information of the session and the session having a track of packet-write mode.

22. The method of claim 16, further comprising utilizing the optical disk drive to access the program memory area (PMA) of the optical disk and the table of contents (TOC) of a session having the target track, and to determine if any track of packet-write mode exists in the session, wherein if the TOC and PMA exist with recording the track information of the target track, no track of packet-write mode exists in the session, and no track of the session has link blocks in step (a), the write mode of the target track is data-at-one (DAO), session-at-once (SAO), or RAW.

23. The method of claim 16, further comprising utilizing the optical disk drive to access the program memory area (PMA) of the optical disk and the table of contents (TOC) of a session having the target track, and to determine if any track of packet-write mode exists in the session, wherein if the TOC and PMA exist with recording the track information of the target track, no track of packet-write mode exists in the session, and a track of the session has link blocks in step (a), the write mode of the target track is track-at-one (TAO).

24. The method of claim 16, wherein the optical disk drive is a read-only optical disk drive or a recordable optical disk drive.

25. An optical disk drive for utilizing the method of claim 16 to determine the write mode of a track of an optical disk.

26. A method for identifying track capacity of a track of an optical disk in an optical disk drive, the method comprising:
(a) setting actual capacity of a target track as the size of the target track excluding its pre-gap when the write mode of the target track is a first type; and
(b) setting actual capacity of the target track as the size of the target track excluding its pre-gap and at least a part of link blocks when the write mode of the target track is a second type;
wherein the target track comprises a plurality of link blocks when its write mode is the second type.

27. The method of claim 26, wherein the first type of write mode is disc-at-once (DAO), session-at-once (SAO), or RAW.

28. The method of claim 26, wherein the second type of write mode is track-at-once (TAO), fixed packet write (FPKT), or variable packet write (VPKT).

29. The method of claim 28, further comprising setting actual capacity of the target track as the size of the target track excluding its pre-gap and last two link blocks when the write mode of the target track is TAO.

30. The method of claim 28, further comprising setting actual capacity of the target track as the size of the target track excluding its pre-gap and last two link blocks when the write mode of the target track is VPKT.

31. The method of claim 28, further comprising setting actual capacity of the target track as the size of the target track excluding its pre-gap and all link blocks when the write mode of the target track is FPKT.

32. The method of claim 26, wherein the optical disk drive is a read-only optical disk drive or a recordable optical disk drive.

33. An optical disk drive for utilizing the method of claim 26 to identify track capacity of a track of an optical disk.
